(19) United States
(12) Patent Application Publication
(10) Pub. No.: US 2006/0190533 A1
(43) Pub. Date: Aug. 24, 2006

(54) System and Method for Registered and Authenticated Electronic Messages

(75) Inventors: Marvin Shannon, Pasadena, CA (US); Wesley Boudville, Perth (AU)

Correspondence Address: MARVIN SHANNON, 3579 EAST FOOTHILL BLVD, #328, PASADENA, CA, 91107, US

(73) Assignees: Marvin Shannon, Pasadena, CA (US); Wesley Boudville, Perth (AU)

(21) Appl. No.: 11/307,733

(22) Filed: Feb. 18, 2006

Related U.S. Application Data
(60) Provisional application No. 60/593,878, filed on Feb. 21, 2005.

(51) Int. Cl. G06F 15/16

(52) U.S. Cl. 709/203

(57) ABSTRACT

We show how to use a browser plug-in and a central Registrar server, to let users send registered or validated electronic messages in a lightweight manner, without using computationally expensive Public Key Infrastructure methods. To users, it is analogous to post office certified or registered mail. Our method can be done if the users, as senders and recipients, are at major ISPs, who have web pages for writing and reading messages, whose structure is known or can be found by the plug-in. Our method does not need the involvement of the ISPs, though that would facilitate some operations.

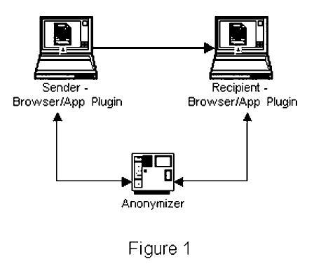

### CROSS-REFERENCES TO RELATED APPLICATIONS

This application claims the benefit of the filing date of U.S. Provisional Application, No.

60/593,878, “System and Method for Registered and Authenticated Electronic Messages”, filed Feb. 21, 2005.

### REFERENCES CITED

antispam.yahoo.com/domainkeys
openspf.org
microsoft.com/mscorp/safety/technologies/senderid/default.mspx
antiphishing.org
webopedia.com/TERM/W/Web_beacon.html
“Understanding PKI: Concepts, Standards and Deployment Considerations” by Adams and Lloyd, Addison-Wesley 2002.
“The Art of Computer Programming” by Knuth, Addison-Wesley 1998.
“XML in a Nutshell” by Harold and Means, O'Reilly 2004.
“J2EE Web Services” by Monson-Haefel, Addison-Wesley 2003.

### TECHNICAL FIELD

This invention relates generally to information delivery and management in a computer network. And specifically to the delivery and management of electronic mail, and other electronic messaging methods.

### BACKGROUND OF THE INVENTION

Since the inception of email over the Internet, it has been very successful. The first “killer app”. But several problems have emerged as the popularity and business importance of email has grown.

The first is authentication. Virtually any field in an email message can be changed en route to the destination machine, and there is no intrinsic means in the mailing or Internet protocols to detect this. One consequence has been the rise of spam, and the pernicious subset of it, phishing. Spammers can forge the sender address, in order to hide their origin. To combat this, various alternatives have been proposed. Sender ID, SPF and Domain Keys, amongst others. These try to authenticate the sender of a message. But even their proponents say it will take several years for a majority of email providers to implement. And even then, there have been technical questions raised about the efficacy of each.

Another group of methods typically use some type of public key infrastructure [PKI]. A sender might be issued a public and private key from a PKI vendor. Then the sender installs special software on her machine. When she sends a message, the software hashes it and then signs the hash with her private key, and appends the result to the message. The recipient has similar software. Almost invariably, this software must come from the same vendor that the sender used. The software gets the sender's public key and applies this to the signed hash. The result is compared to that found from directly operating on the message. If they are the same, then the message was from the sender and was unaltered in transit.

PKI methods have problems of their own. They are computationally very expensive to perform. Both at the sender and recipient. Plus, as mentioned, interoperability between vendors is limited. Another problem is that of key management. The protocols for issuing and revoking of public and private keys is complex, and adds to the cost of the methods. Also, a PKI implementation is a strong cryptosystem. Some countries, like the United States, might restrict the export of these if the key length in the PKI exceeds a certain amount. While other countries might restrict the possession or usage of such implementations within their borders. Since the email problem is global, such restrictions greatly hamper the deployment of a global solution.

A second problem has been the lack of certain analogs to physical mail. No proof of mailing. No indication that a sender has received and read the message.

For the latter, one solution has been web beacons. These are usually image tags in an HTML message, where the source of the image is downloaded from the sender's website. This source is a URL that has an encoding of the recipient's address. Often, the image is small, like a black dot, so that the recipient does not even know that this is happening. The image is loaded when the recipient reads the message in a browser, which automatically displays the HTML and loads the image. Thus, the sender's website server knows that the message was sent to a real address and was read. Such techniques are often used by spammers, to see which addresses in their mailing lists are real and active. And hence worth more to a spammer and are more likely to get more spam in the future. For this reason, the use of web bugs is a style (heuristic) that when detected by some antispam methods, might increase the probability that the message will be classified as spam. Related to this, some recipients might read their mail, but in a web page where they can turn off the display of any images.

Therefore, the usage of web beacons may be deemed unsatisfactory by a sender who does not wish to be considered a spammer. Plus, if the sender want to use web beacons, she needs her own website that images are downloaded from. In general, web beacons cannot be used by a user at some ISP. That ISP might do so, with its own mailings. But its users don't have that capability.

### SUMMARY OF THE INVENTION

The foregoing has outlined some of the more pertinent objects and features of the present invention. These objects and features should be construed to be merely illustrative of some of the more prominent features and applications of the invention. Other beneficial results can be achieved by using the disclosed invention in a different manner or changing the invention as will be described. Thus, other objects and a fuller understanding of the invention may be had by referring to the following detailed description of the Preferred Embodiment.

We show how to use a browser plug-in and a central Registrar server, to let users send registered or validated electronic messages in a lightweight manner, without using computationally expensive Public Key Infrastructure methods. To users, it is analogous to post office certified or registered mail.

Our method can be done if the users, as senders and recipients, are at major ISPs, who have web pages for writing and reading messages, whose structure is known or can be found by the plug-in. Our method does not need the involvement of the ISPs, though that would facilitate some operations.

### BRIEF DESCRIPTION OF THE DRAWINGS

There is one drawing. It shows a sender with a browser and plug-in, sending a message to a recipient, and both sender and recipient can communicate with a Registrar.

### DETAILED DESCRIPTION OF THE PREFERRED EMBODIMENT

What we claim as new and desire to secure by Letters Patent is set forth in the following claims.

We described a lightweight means of detecting phishing in electronic messages, or detecting fraudulent web sites in these earlier U.S. Provisionals: No. 60522245 (“2245”), “System and Method to Detect Phishing and Verify Electronic Advertising”, filed Sep. 7, 2004; No. 60522458 (“2458”), “System and Method for Enhanced Detection of Phishing”, filed Oct. 4, 2004; No. 60552528 (“2528”), “System and Method for Finding Message Bodies in Web-Displayed Messaging”, filed Oct. 11, 2004; No. 60552640 (“2640”), “System and Method for Investigating Phishing Websites”, filed Oct. 22, 2004; No. 60552644 (“2644”), “System and Method for Detecting Phishing Messages in Sparse Data Communications”, filed Oct. 24, 2004; No. 60593114, “System and Method of Blocking Pornographic Websites and Content”, filed Dec. 12, 2004; No. 60593115, “System and Method for Attacking Malware in Electronic Messages”, filed Dec. 12, 2004; No. 60593186, “System and Method for Making a Validated Search Engine”, filed Dec. 18, 2004.

We will refer to these collectively as the “Antiphishing Provisionals”.

Below, we will also refer to the following U.S. Provisionals submitted by us, where these concern primarily antispam methods: No. 60320046 (“0046”), “System and Method for the Classification of Electronic Communications”, filed Mar. 24, 2003; No. 60481745 (“1745”), “System and Method for the Algorithmic Categorization and Grouping of Electronic Communications, filed Dec. 5, 2003; No. 60481789, “System and Method for the Algorithmic Disposition of Electronic Communications”, filed Dec. 14, 2003; No. 60481899, “Systems and Method for Advanced Statistical Categorization of Electronic Communications”, filed Jan. 15, 2004; No. 60521014 (“1014”), “Systems and Method for the Correlations of Electronic Communications”, filed Feb. 5, 2004; No. 60521174 (“1174”), “System and Method for Finding and Using Styles in Electronic Communications”, filed Mar. 3, 2004; No. 60521622 (“1622”), “System and Method for Using a Domain Cloaking to Correlate the Various Domains Related to Electronic Messages”, filed Jun. 7, 2004; No. 60521698 (“1698”), “System and Method Relating to Dynamically Constructed Addresses in Electronic Messages”, filed Jun. 20, 2004; No. 60521942 (“1942”), “System and Method to Categorize Electronic Messages by Graphical Analysis”, filed Jul. 23, 2004; No. 60522113 (“2113”), “System and Method to Detect Spammer Probe Accounts”, filed Aug. 17, 2004; No. 60522244 (“2244”), “System and Method to Rank Electronic Messages”, filed Sep. 7, 2004.

We will refer to these collectively as the “Antispam Provisionals”.

In our Antiphishing Provisionals, we discussed various means of attacking phishing messages and websites that misrepresent themselves as other companies, where the latter companies are often in the financial sector. From the use of those Provisionals, we can detect most phishing messages with links to those companies. Here, we extend the scope by showing how to use the plug-in and a modification of the Aggregator, to send electronic messages that can be registered or authenticated.

In what follows, we describe the use of the plug-in inside a browser. Our method also holds when the plug-in is used inside any program that can show electronic messages and display and have functional any hypertext in those messages. Our method also applies if the functionality of the plug-in is incorporated into a browser.

In the Antiphishing Provisionals, we described a server, which we called an Aggregator, that performs certain tasks. In this method, it takes on a special role, which we call a Registrar.

In “2528” we described how to use the plug-in when reading a message purportedly sent by a company whose Partner Lists are known to the Registrar. Here, the message is being viewed in a brower, and has been sent to some ISP, for which the plug-in knows how to isolate the message body in the HTML page. “2528” described the validation of any extracted links in the message body, against the company's Partner Lists. We extend “2528” to handle the sending of a message, and not just the reading of a received message.

Consider again Jane, who has a plug-in in her browser, and she is registered with the Registrar as a user of that plug-in. She has an email address of jane@someisp.com. She wants to send an email to Dinesh, at dinesh@elsewhere.com. Jane logs into someisp.com, and goes to the appropriate page to write a message. She does so. But before sending it, she can do the following. She brings up the plug-in's menu and picks the option called “register message”, say. The option name is arbitrary, but we make that choice of name, so as to convey a useful intent to her.

The option does the following. We assume that the plug-in knows about the structure of someisp's message writing page, so that it can find the body of the message that Jane has just written. Plus, optionally, the subject line, sender line, To line and the Cc line. The plug-in might either have hardwired logic specific to someisp, that knows how to isolate the information, or someisp might publish the delimiter information (as a Web Service perhaps), so that the plug-in can access it. This is very much along the lines of “2528”, where that described finding delimiters for the display of a received message. It is a natural extension of that to finding delimiters for the display of a message that will be sent.

Optionally, Jane can put tags into her message body, to delimit only that part or parts which she wants to have validated. These are custom tags publicly defined by the Registrar, for such a usage. The inserting of such tags might be done manually by her, especially if she is writing her message in a markup language like HTML. Or, the ISP's message writing page, which is essentially a specialized program, might have the ability to let her indicate the start and end of each part, and the program then inserts the tags. This is similar to how one might explicitly write a document in HTML, or use an HTML editor that frees one from having to need specialized knowledge of the HTML tags.

Hence, the plug-in can make one or more hashes from the extracted information that Jane has just written. Though optionally, only one hash might suffice. Without loss of generality, we shall assume the latter, though we later discuss the case of multiple hashes. The plug-in then sends the hash to the Registrar. With possibly the electronic address of Jane at someisp, or perhaps just the datum that the message will be sent from someisp.com. The latter is found from the URL of the message composing page, and was already used by the plug-in, to see if someisp is in its list of known ISPs, with known message delimiters.

The Registrar now has (hash, address). Where the address is Jane's network address at someisp. Optionally, perhaps instead of, or in addition to, it might be some other kind of id for Jane. Remember that Jane is a known customer of the Registrar, so during her sign-up, she may have been required to furnish some kind of id that the Registrar validated by some other means.

Optionally but preferably, the Registrar writes a timestamp, and thus stores the triplet (hash, address, time). Note that the Registrar never has access to the text of the message. And that the computational cost of finding the hash is borne by Jane's computer.

The Registrar can then send a reply to the plug-in that the hash was successfully recorded. The plug-in can then indicate in some fashion to Jane that the Registrar received and recorded her hash. Or, the Registrar can email that reply to Jane, so that she has a convenient record of it in her mailbox. Jane might be able to choose which type of reply she prefers.

Optionally, the plug-in might append text to the message body, explaining how to download a plug-in, and register with the Registrar, in order to validate messages. This text might also include a link to the Registrar's website. It can be useful to Jane, by letting any of her recipients who do not have a plug-in obtain one, in order to verify her messages. (And messages from others, of course.) That notwithstanding, Jane might have the ability to instruct her plug-in not to append the text.

Jane now sends the message to Dinesh by pressing the appropriate button in her ISP's web page. An alternative is for the plug-in to also perform the sending of the message. By knowing the structure of the ISP's page, the plug-in also knows how to submit the message from Jane's computer to the ISP's server. Doing it saves Jane one operation. It also gives Jane proof of mailing, since the plug-in executed the mailing.

At some later time, Dinesh is logged into his account at elsewhere.com. Here we suppose that Dinesh also has a plug-in on his computer, and that the plug-in knows about how elsewhere.com, as an ISP, displays its received messages in a web page. In “2528”, we described how the plug-in can validate received messages from companies known to the Registrar, where validation meant checking the links in the message. But “2528” did not describe what happened when Dinesh is reading a message that is not from those companies.

Now, suppose he is reading Jane's message. He can go to the plug-in's menu and pick the option called “check”, say. This causes the plug-in to extract the body of the message, and, optionally, the other fields, and hash it.

There is an important detail when isolating the body of the message. If the body has delimiters when Jane put in, to indicate what portions should be hashed, then these portions can be extracted by the plug-in. But suppose the body lacks the delimiters. By default, all of the body should be hashed. With this caveat. Some ISPs append a text signature to an outgoing message. This text usually is an advertisement for the ISP, typically with a link back to the ISP. The plug-in has knowledge of which of the ISPs known to it does this. And for those ISPs, what is the appended text. Hence the plug-in does not include such text when finding hashes.

Related to this is if Jane's plug-in appended text describing how to get an instance of the plug-in, as described earlier. The plug-in can detect the presence of such known text, and not hash it.

Then, the doublet (hash, address) is sent to the Registrar. Which checks it against its data, and replies “yes” or “no” (or codes equivalent to these), based on the check. Suppose it finds “yes”. It can record the address of Dinesh, and the time when this validation was done. And likewise for any others would got a valid copy of Jane's message. These results can be conveyed to Jane in some fashion, as in an email, for example. Or, Jane could query the Registrar and ask for a list of who validated her message, and when those validations were done. This is analogous to a post office's registered mail and the proof of delivery.

The ability of Jane to store her message hash, and for Dinesh to check it, means that the Registrar might charge one or both of them for this service. While the ability for Jane to find who has validated her messages might be an extra charge for her.

The Registrar can use the optional timestamp associated with a hash as a basis for removing the data after some default period of time has elapsed. There is also the possibility that when Jane uploaded the hash, she made a choice of a longer storage time. The Registrar might levy an extra fee for this choice.

An extension is possible if, when a hash expires, the Registrar moves the (hash, address) into another table, for expired hashes. Then, if it gets a query hash, it first checks that against the table of unexpired hashes. If not present, then it checks against the table of expired hashes. If the hash is present in the latter, the Registrar might reply “no—expired”. Or it might just reply “no”. Optionally, it could also record the (address, timestamp) of whoever asked for this expired hash. Such information might be made accessible to Jane, in the fashion described earlier. Naturally, if a table of expired hashes is kept, entries would be deleted from this after some duration.

An extension is possible, that relates to whether Dinesh is able to prevent Jane from knowing if he successfully [or unsuccessfully] validated her message. The Registrar might allow this, as a premium service. Or, the Registrar might let Jane prevent this, as a premium service to her. In other words, if Jane chooses this service, she will always be able to know who validated her message.

An extension is possible, where Jane can specify the maximum number of validations of her message. This number might be less than the number of recipients, or equal to it, or more. Why? Consider when she chooses the number, n, to be less than the number of recipients, m. She might want the first n people who validate her message. Imagine a marketing promotion, where she wants recipients (buyers?) to respond as soon as possible. Of course, she could avoid our method entirely, and just send out an unvalidated message. But perhaps she wants her recipients to have some confidence that the message she sends is real, and not spoofed by some phisher, say. In any event, when counting the number of validations, a recipient is only counted once. This is to prevent a recipient repeatedly validating, in order to prevent other recipients from validating.

An extension is possible, where the Registrar can set a policy of whether a recipient can repeatedly validate a message or not. The Registrar might have different policies for different recipients. This can be used to prevent an attack where a recipient, or a computer program masquerading as a recipient, makes many validation requests for a message, in order to tie up the Registrar's computations.

An extension is possible, where once Jane uploaded her hashes, at some future time, she asks the Registrar to remove these, before they have expired. The Registrar might charge a fee for this service.

An extension is possible, where Dinesh can use the plug-in to classify the message as one of several types. These types might include “phishing” and “spam”, where the latter means a spam that is not a phishing message. The plug-in sends (hash, Dinesh's address, type) to the Registrar. Where the type would optionally but preferably be encoded as an integer, for brevity, instead of those strings. If the message is known to the Registrar (its hash exists in the Registrar's database), then it can make an array for that message, where each position in the array is given by a type, and the value in a position is the number of unique recipients who classified it as such. Naturally, for a given message, we only let a recipient vote once. Then, for a given sender, the Registrar can construct an array, across all the sender's messages, summing up these votes. This is an important feedback mechanism that lets the Registrar control improper usage.

Above, we described how the sender used a two step process to upload the hash to the Registrar. And how the recipient did similarly. In both cases, the user brought up the plug-in menu and picked an appropriate option from it. We also include a slight alternative in the user interfaces such that this could be done in one step, by pressing an appropriate button in the browser, or by using a keyboard accelerator (a combination of key presses), for example.

Above, we described how the Registrar stored and checked the hashes. It could instead be another company affiliated with the Registrar that does this. Also, we discussed the case of email. In general, our method can be used with any electronic messaging modality, including, but not limited to, SMS.

Authenticating Files

It is also possible for Jane to use the plug-in to compute and upload a hash of a file, containing arbitrary data. For example, the plug-in might have an option that invokes a file browser. This lets her go to a file on her computer. Then, assuming that the plug-in has read permission on the file, it hashes the file and uploads the hash to the Registrar. Optionally, Jane may be able to give some information about the file (metadata) that is also uploaded. The Registrar may choose to store this (hash, metadata, address) in a different table than that used for messages.

Then, if Dinesh gets this file, by whatever means, he can use his plug-in to hash it and query the Registrar to see if it has any information about the file. If so, the Registrar downloads the metadata and Jane's address to his plug-in. Optionally, but preferably, the information is in XML form. And the plug-in might also offer an API that offers this information to a local program, in XML form. This lets third party programs easily run the plug-in and use its results.

Why is this necessary? Can't Jane just send the file as an email attachment, and use the techniques we described earlier to let a recipient authenticate the file? One problem is that many email servers place limits on the maximum size of an email. So when Dinesh gets this file, it might be by other means. For example, Dinesh might have a computer on the network with an ftp server, that lets an outsider download a file into the computer. He might then want to ascertain the provenance of such a file, using our method, if for no other reason than to guard against malware.

It should be noted that a simple idea, of using the Registrar to store hashes of known viruses or worms and having users check for these, may be of limited use. Most malware is in binary form. In which the author could add several arbitrary bits in every unique instance, that do not affect the execution, in order to make unique hashes. Our idea works best against non-malware, where the authors have no incentive to do this.

An extension is possible, where the plug-in can be run in standalone mode, independently of a browser. In part, this mode might be to facilitate the authenticating of files.

Antispam

We now discuss one possible reason why the plug-in might make several hashes from the user's message. Before doing such hashing, it might also apply our antispam canonical steps in the Antispam Provisionals to the input text. Because we need to guard against a spammer who might register with the Registrar, and then send validated messages. And also to guard against a non-spammer user who gets her account subverted by a spammer, who then uses it to send validated messages. Above, we mentioned how the Registrar might charge the sender for each message. If not, or in addition to, it might place a daily limit, say, on the number of validated messages per sender. These will act to restrain spam.

But we can also use the Antispam Provisionals and the making of multiple hashes per message, to construct Bulk Message Envelopes [BMEs]. So if a spammer starts with a template of a message, and introduces spurious random elements to make unique messages, and uploads the hashes from each message, the Registrar has a means of collating these together as one intrinsic message, held in a BME. Also, it can check if several users upload the same set of message hashes. It can make user clusters and hash clusters. Plus, by making several hashes per message, there is the means of investigating BMEs that are similar. Optionally, during the canonical steps done by the plug-in, it might find the base domains of any links in the text, and upload these. So that the Registrar can then find domain clusters. Thus, we can apply most if not all of the techniques of “1745”, “1789” and “1899”, to hinder spammers from using our validation method.

Whether or not a plug-in does canonical reduction steps and makes multiple hashes for a message can be controlled by the Registrar. The Registrar might use complex adaptive logic to have this done for certain senders, whereas other senders might just have no canonical reduction and one hash per message. It necessitates that the Registrar hold at least two tables of hashes. One table is for hashes, where each message only produces one hash. The other table is for hashes, where multiple hashes are made from a message. A sender might have the plug-in only make one hash per message, and then at some later time, the Registrar might instruct it to make multiple hashes. This lets the Registrar apply more detailed analysis for certain users, that it might suspect of being spammers. Based possibly in part on the number of complaints about a sender, submitted by its recipients to the Registrar.

Part of the information that the Registrar uses to determine whether to make multiple hashes for a given sender might be based on feedback from recipients of its earlier messages. We had previously described how recipients might be able to classify messages for the Registrar. This is one possible use of that information.

Scaling

An issue arises as to how well the Registrar can scale globally. It can be seen that its computational and storage requirements should be much less than that of a search engine. Firstly, it has no need to spider the web. Users submit data to the Registrar. This reduces some of the complexity.

Most of all, the Registrar's data have very simple structure. A search engine has to deal with hyperlinked data, and each web page can have many associated fields, like META tags. Plus, the queries that a Registrar gets are far simpler than those gotten by a search engine. There is no potentially elaborate syntax. And the searching is simpler. Only one result is returned, which is a code for “yes”, “no” and possibly “no—expired”. Whereas a search engine has to collate potentially many results, rank them in some fashion, and return a subset of these.

Another issue is the coverage of ISPs by the plug-in. Initially, the plug-in can be written to handle the 10 largest ISPs in the world, say. It can be written such that modules to handle more ISPs can be downloaded to it from the Registrar. Or, an existing module in the plug-in, that deals with an already covered ISP, might be replaced by a more recent one from the Registrar. Or, if an ISP publishes its message delimiters, possibly as a Web Service, then the plug-in might periodically go directly to it, to download the latest delimiters.

Note that for a given ISP, the HTML source of web pages it publishes to a browser, for writing or reading a message, is available for inspection by any of its users. Even in principle, an ISP cannot conceal this layout. Hence, if it does not offer a Web Service that defines its message delimiters, these can still be easily found from those web pages, and manually encoded into an appropriate module. The coding is straightforward. Plus, the binary for each module is not expected to be large. So the overall size of the plug-in need not be a constraining factor, given the size of memory and disk in current computers.

However, it would indeed simplify the coding if most ISPs offered a Web Service for their delimiters. For the largest ISPs, we can explicitly inspect their web pages and code in delimiters. For smaller ISPs, there is an incentive for them to offer a Web Service. Because they have fewer customers, there is less need for the plug-in's author to explicitly inspect their web pages to get the delimiters. By conforming to running this Web Service, they still have no constraints regarding the visual presentation of their pages. Our method does not care about that.

Hence our method can scale down to many small ISPs, without exacerbating code size or maintenance.

But there is another class of message providers. Companies or organizations that do so for their employees or members. These differ from ISPs insofar as typically, you, as a member of the public, cannot sign up with those entities simply by paying money. It should be noted that often, the largest such companies might have less than 50 000 employees. And not all of these will even have email accounts at the company. (Imagine a blue collar assembly line employee, for example.) Whereas the smallest ISPs might have around this number of users. Because an ISP primarily makes most of its money from offering the Internet connectivity or messaging, and it is not economic for an ISP to be much smaller than this. This means that even the largest company might have very little leverage over the plug-in incorporating knowledge of its custom web messaging pages. So most companies may have incentive to operate a Web Service to promulgate their delimiters.

Alternatively, the plug-in's author may specifically have knowledge of particular companies, and might charge for the inclusion of this knowledge.

Generalized Plug-In

The plug-in can be generalized to be more than just fitting into a program that can show hyperlinked documents. For example, imagine a program that is used to design the layout of semiconductor chips. These often have data objects that describe circuits, and let the user combine these into larger circuits. Sometimes, these objects are known as standard cells. The objects might be obtained from various external sources. The plug-in could take such an object, hash it and ask the Registrar for validation.

Or imagine a program that does mechanical engineering design. It might use data objects that describe parts designed by others. Here, the plug-in might do the same as in the previous example.

Or imagine a program that is an Integrated Development Environment for computer programming. It might have libraries, in source code or binary form, written by others. The IDE might have a plug-in to allow validation of these libraries.

Of course, in the above examples, the plug-in can also permit the submission of such object hashes, and associated metadata, to the Registrar.

The general case is this: Consider a program that uses data objects of uncertain provenance. Typically, these might be obtained from sources outside the company. The program can have a plug-in that permits the validation of such an object. By hashing it and submitting the hash to the Registrar to see if the latter has any information about that object. If so, the Registrar can download such information, and the plug-in makes it available to the user. Plus, the plug-in also lets the user submit such hashes and information to the Registrar for objects she has built. A simple variant is that the plug-in might be able to be run separately from the program.

### CONCLUSION

Our method gives a simple means of registering and verifying messages, that preserves the privacy of the users. Our method lets a sender have the analog of a post office proof of mailing or of registered mail. It can perform a full validation of the entire contents of a message's body, or subsets thereof. It does not require a key distribution and usage complexity of a PKI implementation. Nor does it need the cooperation of ISPs, or a reworking of current Internet Protocol standards, in contrast to such proposed methods as Sender ID or SPF.

What is claimed is:

1. A method of a browser plug-in making a hash of an email written within the browser, and sending this hash, along with the sender's address or some unique identifier of the sender, to another computer (“Registrar”), which can optionally attach a timestamp to this data.

2. A method of using claim 1, where the sender can designate which header fields and which portions of the message body to be included in the hashing.

3. A method of using claim 1, where the plug-in sends the message.

4. A method of using claim 1, where a recipient of a message can compute a hash of that message and ask a Registrar if it has a record of the sender and hash.

5. A method of using claim 1, where the Registrar electronically tells the sender or another entity, including but not limited to the recipient, that it has a record of the sender sending that message, with that hash and timestamp.

6. A method of using claim 5, where if the recipient asks the Registrar about a message, and it verifies, then the Registrar notifies the sender that her message was received by the recipient.

7. A method of using claim 5, where the Registrar might not inform the sender if the recipient successfully verified a message with the Registrar; it might do this upon request from the recipient.

8. A method of using claim 5, where the Registrar will ignore any request from a recipient to not inform a sender about a message that was verified; it might do this upon request from the sender.

9. A method of using claim 5, where the sender can restrict the maximum number of times that a Registrar will reply to other entities, asking about a sender's message.

10. A method of a user making a hash of an arbitrary file, and sending this and an id of the user to the Registrar; where the latter can answer queries from others, who present it with a hash and ask if it has a record of this and who registered it, for file authentication.
